(19) United States
(12) Patent Application Publication
(10) Pub. No.: US 2007/0157792 A1
(43) Pub. Date: Jul. 12, 2007

(54) Ocarina

(76) Inventor: Il Yong Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 10/576,747

(22) PCT Filed: Oct. 22, 2004
(86) PCT No.: PCT/KR04/02708

§ 371 Date: Apr. 20, 2006

(30) Foreign Application Priority Data
Oct. 22, 2003 (KR) 2003-0073853
Oct. 22, 2004 (KR) 10-2004-008471

(51) Int. Cl. G10D 9/04; G10D 7/06; G10D 7/00

(52) U.S. Cl. 84/380 R

(57) ABSTRACT

Disclosed is an ocarina in which a musical performance can be performed with an accurate tone and rapidly, by solving problems that, in the case of an existing round type ocarina, various musical performance having high musical range is impossible because a width of the musical range is narrow and the angle of an airway must be changed when music of chromatic scale is performed. According to the present invention, the ocarina includes first to third toneholes (41, 42, 43) formed in the body (1) in a row, wherein the first to third toneholes can be held by three fingers among four fingers except for the thumb of the left hand, fourth and fifth toneholes (44, 45), which can be held by two fingers of four fingers except for the thumb of the right hand, sixth and seventh toneholes (46, 47) disposed adjacent to the fourth and fifth toneholes (44, 45), wherein the sixth and seventh toneholes (46, 47) can be stopped or opened at the same time when the fourth and fifth toneholes (44, 45) are stopped at place extended in the longitudinal direction of the finger, and eighth and ninth toneholes (48, 49), which are formed at the bottom of the body (1) and held by the thumbs of the left hand and the right hand.

### TECHNICAL FIELD

The present invention relates to an ocarina, and more particularly, to an ocarina in which a musical performance can be performed with an accurate tone and rapidly, by solving problems that, in the case of an existing round type ocarina, various musical performance having high musical range is impossible because a width of the musical range is narrow and the angle of an airway must be changed when music of chromatic scale is performed.

### BACKGROUND ART

An ocarina was developed in Italia in the 18^{th} century, and is a musical instrument made of baked ceramic ware. The ocarina has the meaning of a gosling.

The sound of the ocarina is very elegant and simple. When compared with artificial sound, it has a tone, which well matches with the nature. The ocarina is advantageous in that it can be carried easily and it can be flexible in size Thus, it has wide applications even as accessory, which can be also used as a musical instrument.

Generally, Ocarina can be largely classified into a T-shape and a round shape depending on fingering. The T shape ocarina called a duck-shaped ocarina is well known and has a type in which fingers move from a right hand fingering to a left hand fingering like a recorder. The T shape ocarina has been widely used since it has greater musical range than those of the round shape ocarina.

Furthermore, the round type ocarina has various shapes such as a bird and an animal. Most of the round type ocarina has a circular shape. The round type ocarina is advantageous in that it can be easily learnt because it has less fingering holes than the T shape ocarina.

In the round type ocarina, however, a tone is produced with a combination of several holes having a proper size, and musical range is less. Accordingly, the round type ocarina is disadvantageous in that a musical performance with only a tone of about child verse music can be performed.

In this ocarina, generally, musical range, which can be performed in one musical instrument, has 14 tone ranging from a low pitch “Sol” to a high pitch “Fa” in the case of the T shape ocarina. In the case of the round shape ocarina, the musical range is 10 tone from the lowest pitch “Do” to a high pitch “Mi”. In order to solve the above small musical range being the biggest problem of an ocarina, Korean Patent Publication No. 2002-0046262 discloses a T shape ocarina having 14 toneholes in order to widen musical range. This corresponds to extension of low musical range, but does not correspond to extension of high musical range.

In order to solve scant musical range, ocarinas having a variety of sizes have been developed. However, these kinds of the ocarinas cannot be used as a recital.

FIG. 10 is a perspective view illustrating a conventional round type ocarina.

Referring to FIG. 10, the round type ocarina includes a body 1 having a hollow 11 formed in, a mouse piece 2, which is projected toward one side of the body 1 and has an airway 21 into which air is blown, a fipple window 3 through which air outputted from the airway 21 passes so that the hollow 11 generates sound, the fipple window 3 being formed at the opposite side of the airway 21, and toneholes 4 formed to connect the outer side of the body 1 and the hollow 11, wherein two toneholes are formed at the bottom and four toneholes are formed at the top, which are opened/shut by fingers to produce unique tone.

This kind of the ocarina is based on the principle that sound is generated if air is blown into the neck of a bottle. The respective toneholes are opened or shut to generate a variety of sound waves and thus to generate sympathetic sound.

FIG. 11 shows a fingering table of the conventional round type ocarina.

The round type ocarina generally has musical range corresponding to 10 pitches. In the case of the highest pitch “Do” (C#) or a high pitch “Re” (D#), air must be blown into the airway with the musical instrument bent 45 degree. However, the round type ocarina has problems in that it has inaccurate tone and becomes an obstacle to a musical performance of a rapid music.

Furthermore, the ocarina disclosed in Korean Patent Publication No. 2002-0046262 has 14 toneholes in order to widen musical range. If a musical performance is performed with all the fingers including the thumb, however, it is difficult to hold the ocarina in order to cope with all tone. Moreover, this ocarina has a disadvantage in that it is relatively large in size.

Therefore, in an existing Donati type ocarina, most beginners have difficulty in studying beginning “la” tone fingering. Unlike other fingers, in terms of the structure of the human body, a tendon of the fourth finger (ring finger) is connected to the fifth finger (little finger) and the third finger (middle finger). It is thus very difficult to move only the fourth finger (ring finger). More particularly, it is very difficult to lift the fourth finger with all the tonehole being stopped in the left hand.

Furthermore, in the existing Donati type ocarina, as shown in FIG. 13, in the case of the highest pitch “Do”, the top of the tail of the musical instrument must be supported by the little finger of the right hand. In the case of a high pitch “Re”, the body of the left side of the musical instrument must be supported by the second finger of the left hand at the highest pitch “Do” state. In the case of high pitches “Mi” and “Fa”, the bottom of the center of the musical instrument must be supported by the first finger (big finger) of the left hand at the high pitch “Re” state. As such, there is a problem in that fingers must support 3 portions so as to prevent a tone from shaking when performing a musical performance of a high pitch.

Furthermore, the existing ocarina has very small musical range. Thus, there is the need for extension of high musical range.

### DISCLOSURE OF INVENTION

Accordingly, the present invention has been made in view of the above problems, and it is an object of the present invention to provide a new ocarina, which has a wide musical range, i.e., from a low pitch “Fa” to a high pitch “Ra”, and is suitable for a round type fingering rather than a T shape fingering.

Another object of the present invention is to provide a ocarina which can digest all tone within musical range even without changing the angle of an airway.

To achieve the above object, according to present invention, there is provided an ocarina including a body having a hollow formed in, a mouse piece projected toward one side of the body and having an airway into which air is blown, a fipple window through which air outputted from the airway passes so that the hollow generates sound, the fipple window being formed at the opposite side of the airway, and one or more toneholes, which are formed to connect the outer side of the body and the hollow and are opened/shut by fingers to produce unique tone, comprising:

first to third toneholes formed in the body in a row, wherein the first to third toneholes can be held by three fingers among four fingers except for the thumb of the left hand;

fourth and fifth toneholes, which can be held by two fingers of four fingers except for the thumb of the right hand;

sixth and seventh toneholes disposed adjacent to the fourth and fifth toneholes, wherein the sixth and seventh toneholes can be stopped or opened at the same time when the fourth and fifth toneholes are stopped at place extended in the longitudinal direction of the finger; and

eighth and ninth toneholes, which are formed at the bottom of the body and held by the thumbs of the left hand and the right hand.

### BRIEF DESCRIPTION OF DRAWINGS

Further objects and advantages of the invention can be more fully understood from the following detailed description taken in conjunction with the accompanying drawings in which:

FIGS. 1a and 1b are perspective views illustrating the construction of an ocarina according to an embodiment of the present invention;

FIG. 2 is a sectional view of the ocarina shown in FIG. 1 according to an embodiment of the present invention;

FIG. 3 shows a fingering table of ocarina according to a first embodiment of the present invention;

FIG. 4 shows a fingering table according to a second embodiment of the present invention;

FIG. 5 is a plan view of an ocarina according to a second embodiment of the present invention;

FIG. 6 is a plan view of an ocarina according to a third embodiment of the present invention;

FIG. 7 shows a state where the space from which a high tone is outputted is held in the ocarina according to the third embodiment of the present invention;

FIG. 8 shows a state where the little finger of the right hand is positioned at the bottom of the ocarina according to the third embodiment of the present invention;

FIG. 9 shows a state where the ocarina is always supported by the little finger of the right hand and is surrounded by the ring finger of the right hand according to the third embodiment of the present invention;

FIG. 10 is a perspective view illustrating a conventional round type ocarina;

FIG. 11 shows a fingering table of the conventional round type ocarina;

FIG. 12 is a perspective view illustrating a conventional Donati type ocarina; and

FIG. 13 is a view illustrating portions (★) that support the conventional Donati type ocarina and fingers.

### BEST MODE FOR CARRYING OUT THE INVENTION

The present invention will now be described in detail in connection with preferred embodiments with reference to accompanying drawings.

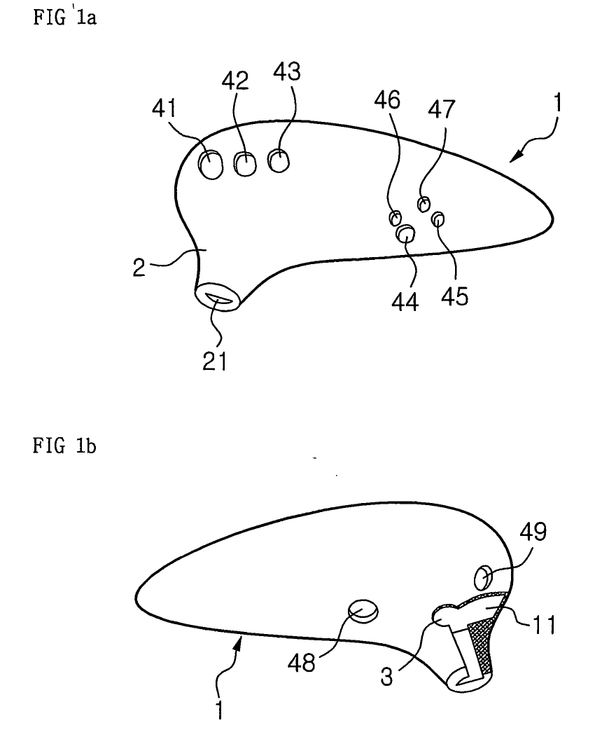

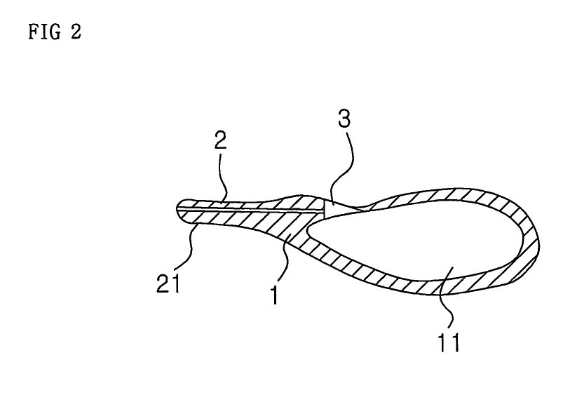

FIGS. 1a and 1b are perspective views illustrating the construction of an ocarina according to an embodiment of the present invention. FIG. 2 is a sectional view illustrating the ocarina shown in FIG. 1 according to an embodiment of the present invention.

Referring to FIGS. 1 and 2, an ocarina includes a body 1 having a hollow 11 formed in, a mouse piece 2, which is projected toward one side of the body 1 and has an airway 21 into which air is blown, a fipple window 3 through which air outputted from the airway 21 passes so that the hollow 11 generates sound, the fipple window 3 being formed at the opposite side of the airway 21, and one or more toneholes, which are formed to connect the outer side of the body 1 and the hollow 11 and are opened/shut by fingers to produce unique tone.

The ocarina further includes first to third toneholes 41, 42 and 43, which are formed in the body 1 in a row, and can be held by three fingers among four fingers except for the thumb of the left hand, fourth and fifth toneholes 44 and 45 which can be held by two fingers of four fingers except for the thumb of the right hand, sixth and seventh toneholes 46 and 47 disposed adjacent to the fourth and fifth toneholes 44 and 45, wherein the sixth and seventh toneholes 46 and 47 can be stopped or opened at the same time when the fourth and fifth toneholes 44 and 45 are stopped at place extended in the longitudinal direction of the finger, and eighth and ninth toneholes 48 and 49 which are formed at the bottom of the body 1 and held by the thumbs of the left hand and the right hand.

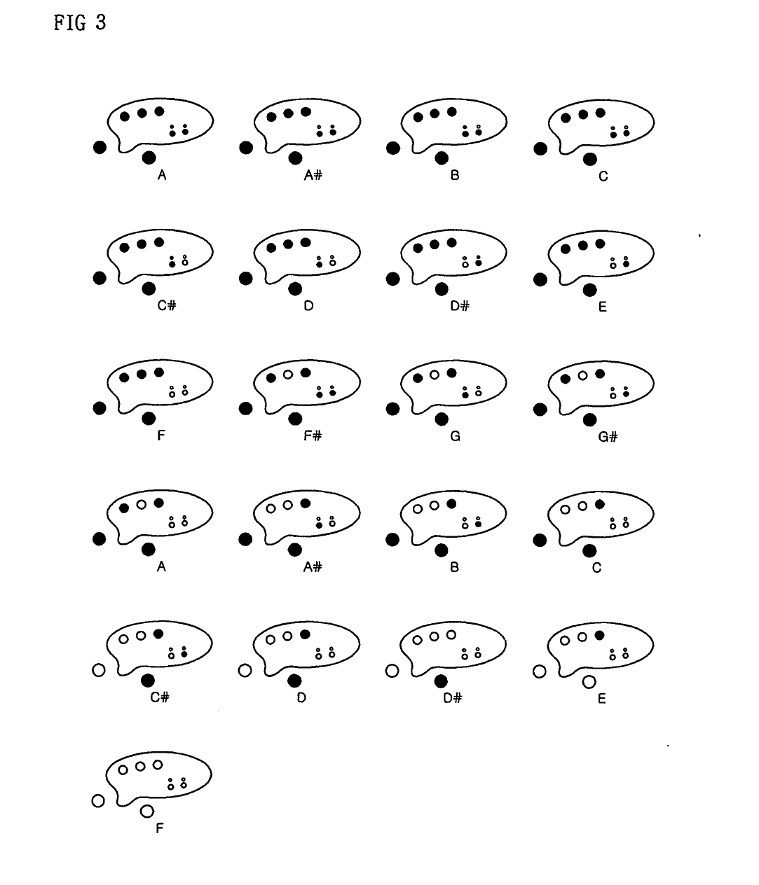

FIG. 3 shows a fingering table of ocarina according to a first embodiment of the present invention.

As shown in FIG. 3, musical range is extended so that a musical performance is possible from a low pitch “la” (A) to “Fa” (F) over 13 pitches. In this time, it can be seen that all tone can be digested although the airway is not blown.

Accordingly, in the case of children's child verse, most song s having musical range of about 10 pitches has a characteristic in that its region is extended up to 17 pitches. Thus, a recital of this music is possible.

Furthermore, this ocarina can digest all tone by only shutting or opening the toneholes with the fingers. This ocarina can be easily handled by a beginner not an expert, can process semi-tone tone of which is inaccurate, and can rapidly perform a musical performance.

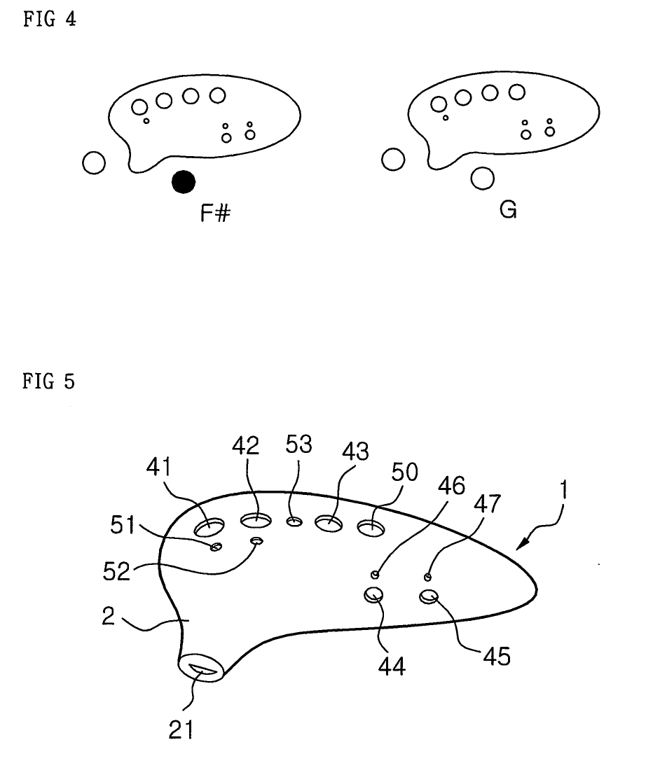

FIG. 4 shows a fingering table according to a second embodiment of the present invention. As shown in FIG. 5, a tenth tonehole 50 is further formed in the body 1 so that it can be held by four fingers except for the thumb of the left hand. An eleventh tonehole 51 is further formed adjacent to the first tonehole 41. The tonehole 51 is formed at a place extended in the longitudinal direction of the fingers so that it can be stopped or opened at the same time when the first tonehole 41 is stopped. As such, musical range is extended up to 17 pitches so that a musical performance of the high pitches “Fa” (F#) and “Sol” (G) is possible.

This corresponds to the invention in which the conventional T shape ocarina, which is disadvantageous in uneasy fingering and large size but advantageous in wide musical range, is combined with the conventional round type ocarina, which is disadvantageous in narrow musical range but advantageous in easy fingering and small size. It is expected that this ocarina will be widely used among average persons who are not accustomed to the conventional.

FIG. 5 is a plan view of an ocarina according to a second embodiment of the present invention. Referring to FIG. 5, eleventh and twelfth toneholes 51 and 52 are further formed adjacent to the first and second toneholes 41 and 42, so that they can be stopped or opened at the same time when the first and second toneholes 41 and 42 are stopped at a place extended in the longitudinal direction of fingers. A thirteenth tonehole 53 is further formed between the second tonehole 42 and the third tonehole 43. Therefore, a musical performance from the low pitch “Fa” to the high pitch “Ra” is possible.

The second embodiment is developed to digest various music compared to an expert musical performer.

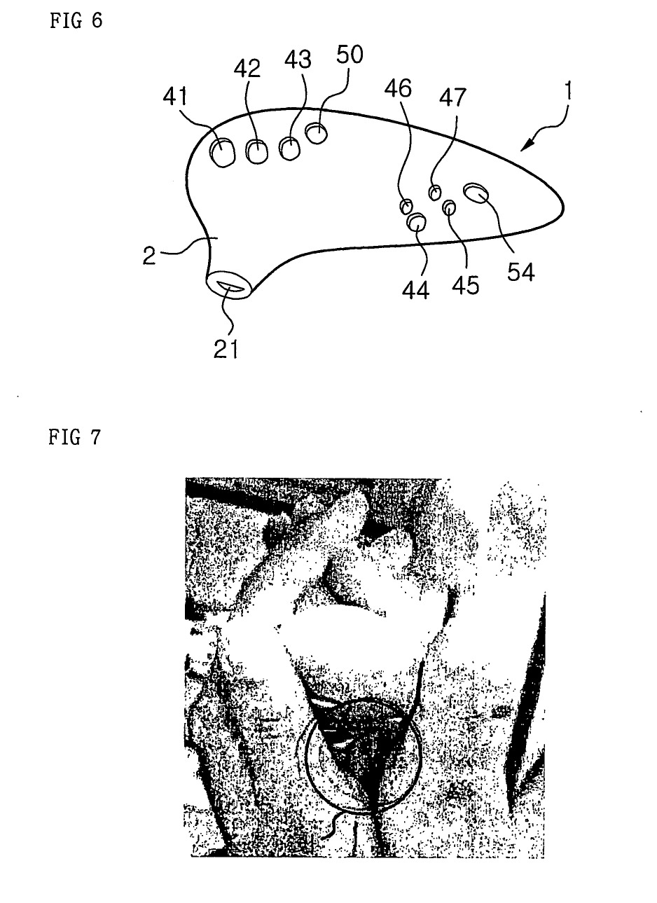

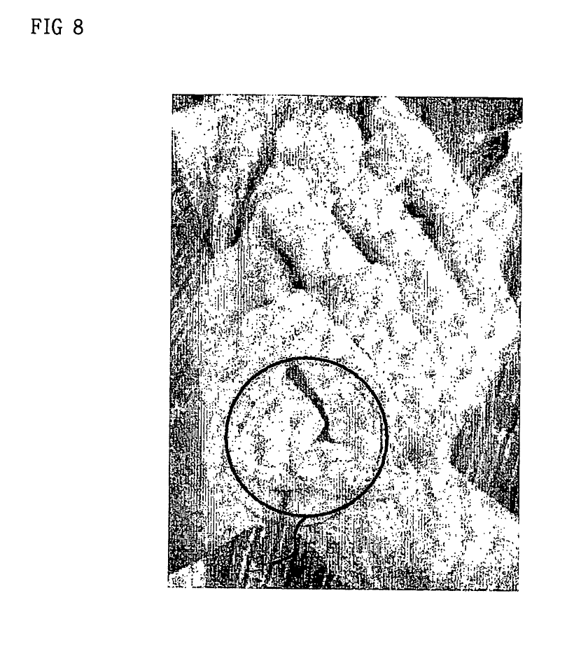

FIG. 6 is a plan view of an ocarina for an expert musical performer according to a third embodiment of the present invention. The ocarina according to this embodiment has a “crossover rendition method” integrated in advantages of the Donati type ocarina and advantages of Langley ocarina so that musical range can be extended up to tone of “3 octave pitch”. To this end, a tenth tonehole 50 is formed in the body 1 and can be thus held by four fingers except for the thumb of the left hand. A fourteenth tonehole 54 is also formed in the body 1 and can be thus held by the second and third finger (index and ring fingers) except for the first finger (thumb) of the right hand. Tone is generated from a fingering hole up to the high pitches “Fa” and “Sol”. The high pitches “Ra”, “Si” and “Do” are generated with the ocarina held by both hands (this posture is called “crossover rendition”) so that the wind does not escape in a state where the ocarina is positioned at the center, as shown FIGS. 7 and 8.

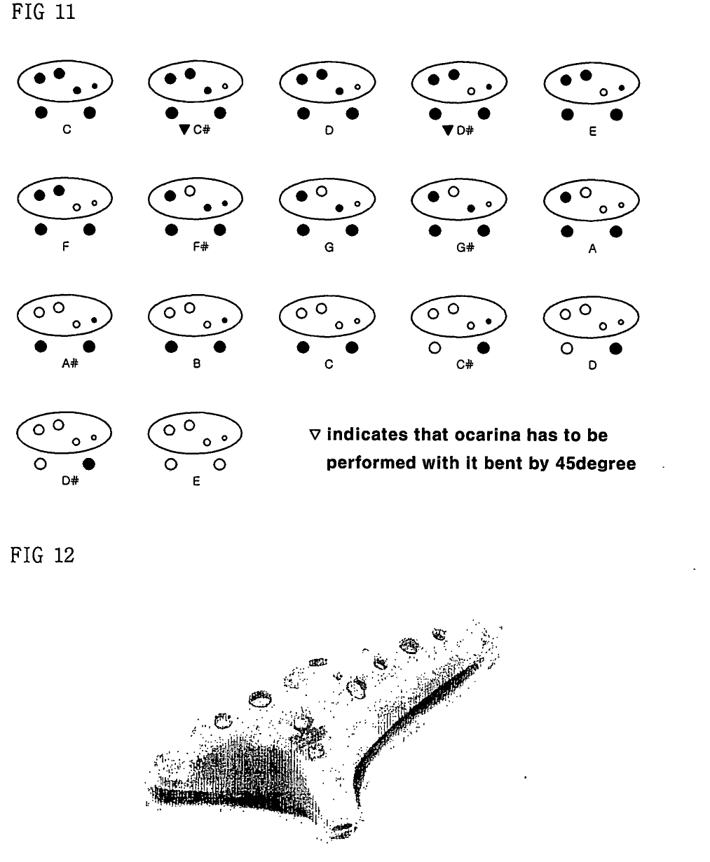

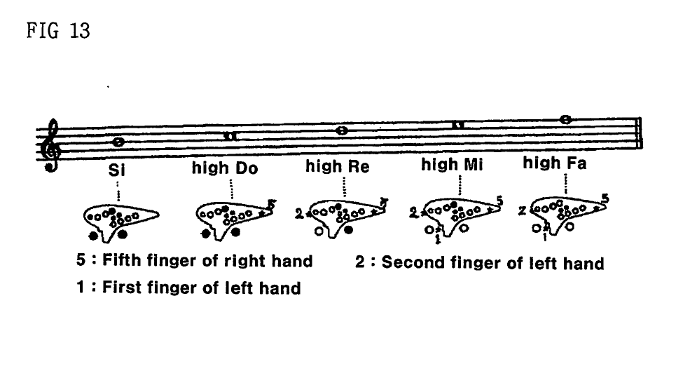

In this time, as shown in FIG. 7, a certain space is defined at the bottom of the ocarina. If the distance between the bottoms of the ocarina is kept about 5 cm by the back of the left hand, “high Sol” tone is generated. When the distance is about 3 cm, “high Ra” tone is generated. When the distance is 1 cm, “high Si” tone is generated. If the distance increases more, 3 octave “Do” is generated. This method is possible by even an existing musical instrument, but a musical performance is impossible in terms of fingering hole method. The reason is that all the fingers are used to stop the fingering hole in the existing ocarina, as shown in FIG. 12. Also, in the high musical range, the fingers used to stop the fingering holes are used to support the ocarina.

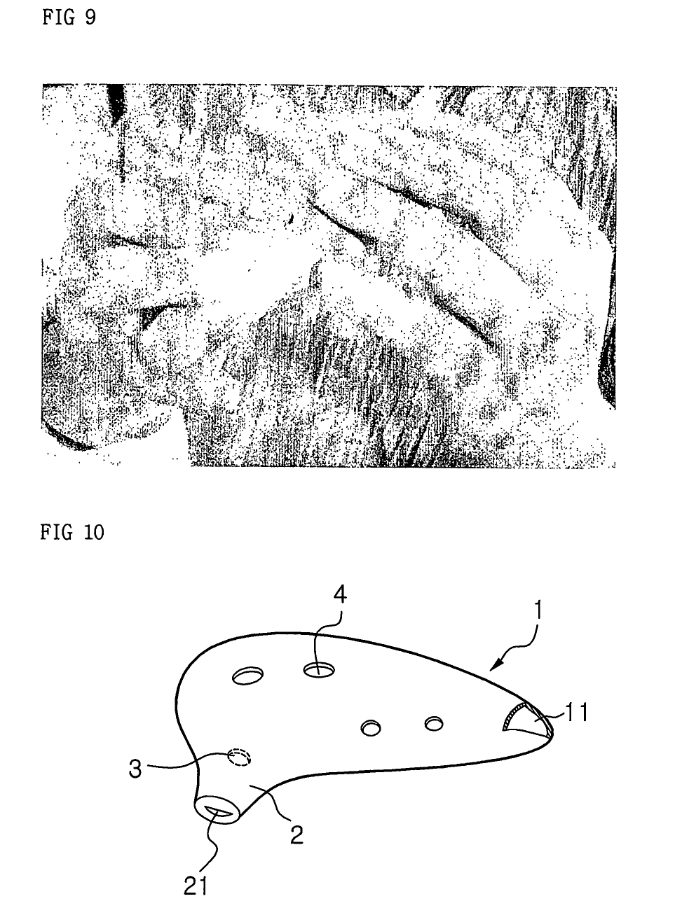

It is impossible to stop the fingering holes of the existing ocarina rapidly and naturally, while taking the posture as shown in FIG. 7. The ocarina of the present embodiment belongs to the Donati type ocarina, but also has the Langley type ocarina. Accordingly, as shown in FIG. 9, the fifth finger (little finger) of the right hand serves to always support the ocarina, not to stop the fingering hole like the existing ocarina. Although the fourth finger (ring finger) takes the posture of FIG. 7 with it surrounding the ocarina, a musical instrument is not moved and the hand can be naturally located to a next behavior.

### INDUSTRIAL APPLICABILITY

As described above, the present invention has an effect in that a musical performance of various music having relative wide musical range can be performed by expanding musical range of a conventional round type ocarina.

Furthermore, the conventional problem in that the angle of an airway has to be changed when performing several tone, is solved with only fingering. It is thus possible to perform not only more accurate tone, but also rapid music.

Furthermore, when performing an ocarina, the little finger of the right hand serves only to support the ocarina. Thus, when high tone is blown, the ocarina can be supported with a minimum force. Even a beginner who studies an ocarina can generate high “Fa” by using the ocarina shown in FIG. 1 without the need to stop the fifth finger (little finger) tonehole and the fourth finger (ring finger) tonehole of the right hand.

Moreover, an ocarina expert can perform a musical performance of various music by using an ocarina which can generate high “Sol” through a fingering hole and “high Sol, Ra, Si and Do” tone through “crossover rendition method”, as shown in FIG. 6. Thus, there is an effect in that music of various genres can be performed like musical instruments.

What is claimed is:

1. An ocarina including a body 1 having a hollow 11 formed in, a mouse piece 2 projected toward one side of the body 1 and having an airway 21 into which air is blown, a fipple window 3 through which air outputted from the airway 21 passes so that the hollow 11 generates sound, the fipple window 3 being formed at the opposite side of the airway 21, and one or more toneholes, which are formed to connect the outer side of the body 1 and the hollow 11 and are opened/shut by fingers to produce unique tone, comprising:
first to third toneholes 41, 42 and 43 formed in the body 1 in a row, wherein the first to third toneholes can be held by three fingers among four fingers except for the thumb of the left hand;
fourth and fifth toneholes 44 and 45, which can be held by two fingers of four fingers except for the thumb of the right hand;
sixth and seventh toneholes 46 and 47 disposed adjacent to the fourth and fifth toneholes 44 and 45, wherein the sixth and seventh toneholes 46 and 47 can be stopped or opened at the same time when the fourth and fifth toneholes 44 and 45 are stopped at place extended in the longitudinal direction of the finger; and
eighth and ninth toneholes 48 and 49, which are formed at the bottom of the body 1 and held by the thumbs of the left hand and the right hand.

2. The ocarina as claimed in claim 1, further comprising:
a tenth tonehole 50 formed in the body 1 so that the tenth tonehole can be held by four fingers except for the thumb of the left hand; and
an eleventh tonehole 51 formed adjacent to the first tonehole 41, wherein the tonehole 51 is formed at a place extended in the longitudinal direction of the fingers so that the eleventh tonehole can be stopped or opened at the same time when the first tonehole 41 is stopped.

3. The ocarina as claimed in claim 2, further comprising:
a twelfth tonehole 52 formed adjacent to the tonehole 42, so that the twelfth tonehole can be stopped or opened at the same time when the tonehole 42 is stopped at a place extended in the longitudinal direction of fingers; and
a thirteenth tonehole 53 formed between the second tonehole 42 and the third tonehole 43.

4. The ocarina as claimed in claim 1, further comprising:
a tenth tonehole 50 formed in the body 1 so that the tenth tonehole can be held by four fingers except for the thumb of the left hand; and
a fourteenth tonehole 54 formed in the body 1 so that the fourteenth tonehole can be held by three fingers among fourth fingers except for the thumb of the right hand.
